(19) United States
(12) Patent Application Publication
(10) Pub. No.: US 2017/0142181 A1
(43) Pub. Date: May 18, 2017

(54) WEBCASTING METHOD, DEVICE AND SYSTEM

(71) Applicants: LE HOLDINGS (BEIJING) CO., LTD., Beijing (CN); LECLOUD COMPUTING CO., LTD., Beijing (CN)

(72) Inventor: Heng HU, Beijing (CN)

(21) Appl. No.: 15/244,217

(22) Filed: Aug. 23, 2016

Related U.S. Application Data
(63) Continuation of application No. PCT/CN2016/083057, filed on May 23, 2016.

(30) Foreign Application Priority Data
Nov. 16, 2015 (CN) 201510785568.3

(51) Int. Cl. H04L 29/06; H04N 21/24; H04N 21/2187

(52) U.S. Cl. CPC H04L 65/605; H04N 21/2187; H04N 21/2407

(57) ABSTRACT

The embodiments of the present disclosure provide a webcasting method, a webcasting device and a webcasting system, wherein the method includes: acquiring webcast data in real time; sending the current webcast data acquired in real time to a webcast server, the current webcast data acquired in real time being transmitted to a webcast client in real time by the webcast server; pausing in sending the current webcast data acquired in real time to the webcast server when prohibited data exists in the current webcast data acquired in real time; and recovering to send the current webcast data acquired in real time to the webcast server when the prohibited data in the current webcast data acquired in real time is completely played. The embodiments of the present disclosure improves the webcasting quality and assures the webcasting security.

### CROSS-REFERENCE TO RELATED APPLACATION

This application is a continuation of International Application No. PCT/CN2016/083057, filed May 23, 2016, which is based upon and claims priority to Chinese Patent Application No. 201510785568.3, filed Nov. 16, 2015, the entire contents of all of which are incorporated herein by reference.

### TECHNICAL FIELD

The embodiments of the present disclosure relate to the field of network technologies, and more particularly, to a webcasting method, a webcasting device and a webcasting system.

### BACKGROUND

Webcasting refers to a play mode capable of viewing video data in different communication platforms through a network system at the same time. The video data mainly includes real time live games, movies, or teleplays, etc.

Contents like product display, related conferences, background introduction, scheme assessment, online surveys, interview dialogue and online training may be released on the internet using a video mode by the webcast that absorbs and carries forward the advantages of the internet, and the promotional effectiveness in the site of activity may be reinforced by utilizing the features of the internet like intuition and speediness, good expression forms, rich contents, strong interactivity, no territory limitation, separable audiences, or the like.

The webcast mode in the prior art is usually that a webcast server acquires webcast data and transmits the webcast data to each webcast client, and then the webcast client plays the webcast data.

However, there may be prohibited contents inappropriate for users to view such as emergencies during the webcast process. Playing these prohibited contents will cause a bad publicity and will also affect the user experience. Therefore, the webcast has hidden network safety hazards.

### SUMMARY

The embodiments of the present disclosure provide a webcasting method, a webcasting device and a webcasting system, for solving the problem that the webcast in the prior art has hidden network safety hazards.

A first aspect of the embodiments of the present disclosure provides a webcasting method, including:

acquiring webcast data in real time;

sending the current webcast data acquired in real time to a webcast server, the current webcast data acquired in real time being transmitted to a webcast client in real time by the webcast server;

pausing in sending the current webcast data acquired in real time to the webcast server when prohibited data exists in the current webcast data acquired in real time; and

recovering to send the current webcast data acquired in real time to the webcast server when the prohibited data in the current webcast data acquired in real time is completely played.

A second aspect of the embodiments of the present disclosure provides a webcasting device, including:

a processor; and

a memory for storing instructions executable by the processor;

wherein the processor is configured to:

acquire webcast data in real time;

send the current webcast data acquired in real time to a webcast server, the current webcast data acquired in real time being transmitted to a webcast client in real time by the webcast server;

pause in sending the current webcast data acquired in real time to the webcast server when prohibited data exists in the current webcast data acquired in real time; and

recover to send the current webcast data acquired in real time to the webcast server when the prohibited data in the current webcast data acquired in real time is completely played.

A third aspect of the embodiments of the present disclosure provides a webcasting system, including: a webcast server, a webcast client and a monitoring platform;

wherein, the monitoring platform is configured with the foregoing webcasting device.

According to the webcasting method, the webcasting device and the webcasting system provided by the embodiments of the present disclosure, the webcast data is acquired in real time and transmitted to the webcast server, then the webcast server transmits the webcast data to the webcast client; if the prohibited data exists in the current webcast data acquired in real time, then sending the current webcast data acquired in real time to the webcast server is paused; if the prohibited data is completely played, then sending the current webcast data acquired in real time to the webcast server is recovered, so that the webcast client will not open the prohibited data, and the user will not view the prohibited contents; therefore, the webcasting quality is improved, the webcast security is assured, and the viewing experience of the user is improved.

### BRIEF DESCRIPTION OF THE DRAWINGS

The drawings illustrated herein are intended to provide further understanding of the present disclosure, constituting a part of the present application. Exemplary embodiments and explanations of the present disclosure here are only for explanation of the present disclosure, but are not intended to limit the present disclosure. In the drawings:

FIG. 1 is a structure diagram of one embodiment of a webcasting system according to the present disclosure;

FIG. 2 is a structure diagram of another embodiment of the webcasting system according to the present disclosure;

FIG. 3 is a flow chart of one embodiment of a webcasting method according to the present disclosure;

FIG. 4 is a flow chart of another embodiment of the webcasting method according to the present disclosure;

FIG. 5 is a structure diagram of one embodiment of a webcasting device according to the present disclosure.

### DETAILED DESCRIPTION

To make the objects, technical solutions and advantages of the embodiments of the present disclosure more clear, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the present disclosure without going through creative efforts shall all fall within the protection scope of the present disclosure.

As described in the background, it is inevitable that prohibited contents inappropriate for the users to view may possibly exist during the webcast process and especially during live webcast, i.e., information is produced and published synchronously with the occurrence and development of an event, and is played in real time through the webcasting system. These prohibited contents will cause a bad publicity, and will also affect the user experience, reduce the webcasting quality, and increase the hidden network safety hazards.

In the present webcasting system, the webcast server acquires the webcast data from a live program source system and sends the webcast data to the webcast client or sends the webcast data to the webcast client through a relay server and a CDN (content delivery network) server. The webcast data is generated by the live program source system according to the live video data filmed or filmed on scene.

In order to solve the hidden safety hazard problem of webcast and improve the webcasting quality, the inventor proposes the technical solutions of the present disclosure upon a series of studies. A monitoring platform may be added in the webcasting system to acquire the webcast data and then send the webcast data to the webcast server, and the webcast data may also be monitored in the monitoring platform; when prohibited data exists in the current webcast data acquired in real time, sending the current webcast data acquired in real time to the webcast server may be paused; when the prohibited data in the current webcast data acquired in real time is completely played, sending the current webcast data acquired in real time to the webcast server may be recovered, so that the user will not view the prohibited contents from the webcast client, which assures the webcast security, improves the webcasting quality, and meanwhile increases the viewing experience of the user.

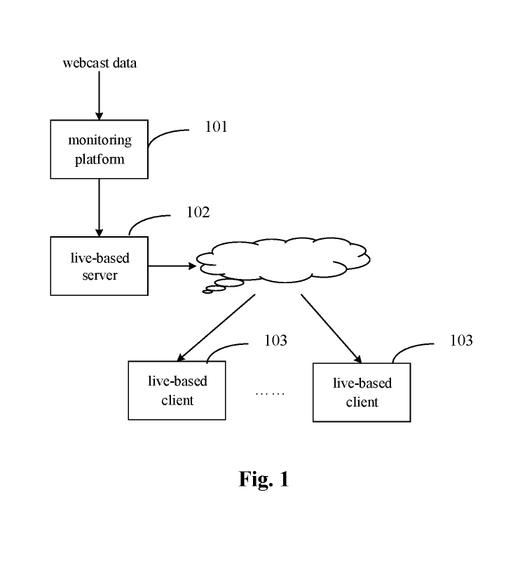

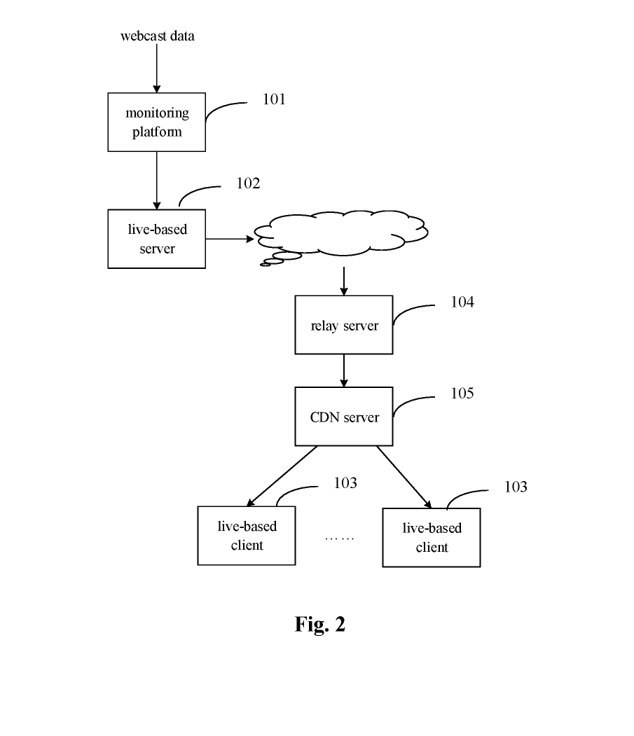

FIG. 1 and FIG. 2 illustrates probable structure diagrams of a webcasting system provided by the embodiment of the present disclosure respectively. In FIG. 1, the webcasting system may include a monitoring platform 101, a webcast server 102 connected to the monitoring platform 101, and a plurality of webcast clients 103 connected to the webcast server 102.

In FIG. 2, the webcasting system includes a monitoring platform 101, a webcast server 102 connected to the monitoring platform 101, at least one relay server 104 connected to the webcast server 102, at least one CDN server 105 connected to the relay server 104, and a plurality of webcast clients 103 connected to the CDN server 105. The CDN servers are distributed in different places, and the webcast data may be delivered to the webcast clients in various places through the relay server and the CDN server. The webcast data may be sent to the closest webcast client through the CDN server, so that the webcast client may acquire needed contents nearby, so that the speed of response may be improved.

The technical solutions of the present disclosure will be described in details hereinafter with reference to the drawings.

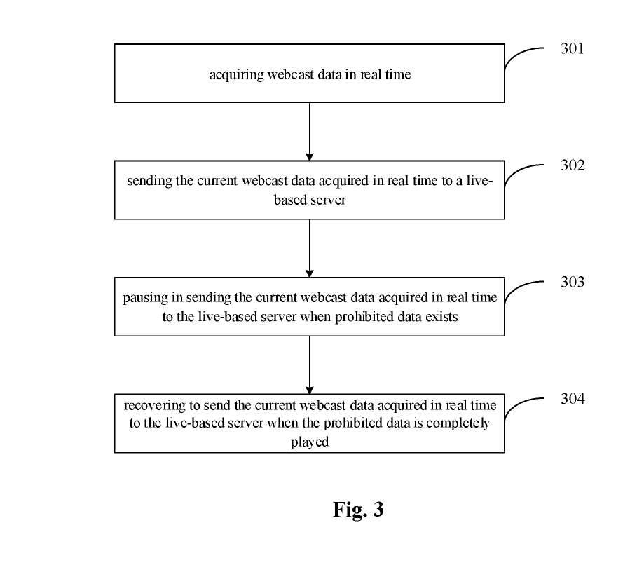

FIG. 3 is a flow chart of one embodiment of a webcasting method provided by the embodiment of the present disclosure. The technical solution of the embodiment may be applied to a monitoring platform as shown in FIG. 1 or FIG. 2, and the method may include the several steps as follows.

In step 301: webcast data is acquired in real time.

In step 302: the current webcast data acquired in real time is sent to a webcast server, the current webcast data acquired in real time being transmitted to a webcast client in real time by the webcast server.

Wherein, the webcast data may refer to live video data, and the webcast client may immediately play the live video data after acquisition.

As another probable implementation manner, in the present webcast protocol, the webcast data transmitted is usually a video data index file, rather than the live video data, wherein the video data index file includes the index information of the live video data, for example, play address, or the like. The webcast client downloads and plays the live video data according to the acquired index information of the live video data in the video data index file.

For example, in a HLS (Http Live Streaming) protocol, the video data index file is namely an M3U8 description file, and the live video data is TS (transport stream) data, wherein the M3U8 description file includes the index information of the TS data, for example, play address, or the like.

In step 303: sending the current webcast data acquired in real time to the webcast server is paused when prohibited data exists in the current webcast data acquired in real time.

In step 304: sending the current webcast data acquired in real time to the webcast server is recovered when the prohibited data in the current webcast data acquired in real time is completely played.

In the embodiment, if the prohibited data is stored in the current webcast data acquired in real time, then sending the current webcast data acquired in real time to the webcast server may be paused until the prohibited data is completely played, and then the current webcast data acquired in real time is sent to the webcast server continuously. Therefore, a user will not see prohibited contents corresponding to the prohibited data at the webcast client, which may improve the webcasting quality and increase the webcasting security.

Because pausing in sending the current webcast data acquired in real time to the webcast server will also disable the webcast client to acquire the webcast data, a problem for interrupting the webcast will appear at the webcast client. Therefore, a live interface cannot display images, for example, a blank screen page or an interface in loading may appear, and the viewing experience of the user will also be affected. Therefore, in order to further improve the webcasting quality, standby data may be sent to the webcast server while pausing in sending the current webcast data acquired in real time to the webcast server when the prohibited data exists in the current webcast data acquired in real time, until the prohibited data in the current webcast data acquired in real time is completely played.

When the webcast data is the live video data, the standby data namely refers to standby video data so as to replace the prohibited data which refers to prohibited video data namely, thus the standby data is played specifically at the webcast client during the prohibited data play stage, so that the user may not see the prohibited contents, and the viewing experience of the user will not be affected, thereby assuring continuous viewing. The standby data, for example, may be advertisement data or data related to the webcast data, or the like.

When the webcast data is the video data index file of the live video data, the standby data may refer to the index information of standby video data so as to replace the prohibited data which refers to the index information of prohibited video data namely, thus the webcast client may download and play the standby video data according to the index information of the standby video data, so that the user may not see the prohibited video data, and the viewing experience of the user will not be affected, thereby assuring continuous viewing. The standby data, for example, may be advertisement data or the index information of data related to the live video data, or the like. In the probable implementation manner, the sending the standby data to the webcast server until the prohibited data in the current webcast data acquired in real time is completely played may particularly include:

updating the current prohibited data in the video data index file acquired as the standby data and send the data to the webcast client.

That is, the standby data is directly added in the video data index file to replace the prohibited data, so that the webcast client downloads and plays the standby data directly according to the index information of the video data index file, i.e., the standby video data of the standby data index may be played during the play moment of the prohibited video data.

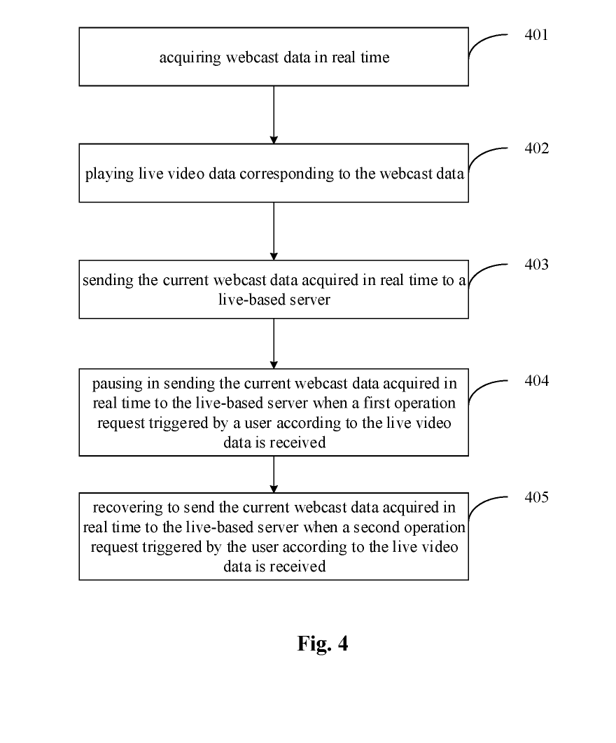

There may be various probable implementation manners for detecting whether prohibited data exists in the current webcast data acquired in real time. As a probable implementation manner, the live video data corresponding to the webcast data may be played for the user to view. To be specific, FIG. 4 is a flow chart of another embodiment of the webcasting method provided by the embodiment of the present disclosure. The method may include the following several steps.

In step 401: webcast data is acquired in real time.

In step 402: live video data corresponding to the webcast data is played.

In the embodiment, the webcast data is a video data index file, and playing the live video data corresponding to the webcast data specifically refers to downing and playing the live video data according to the index information of the live video data in the video data index file.

Certainly, as another embodiment, when the webcast data is live video data, the live video data can be directly played.

In step 403: the current webcast data acquired in real time is sent to a webcast server, the current webcast data acquired in real time being transmitted to a webcast client in real time by the webcast server.

The webcast client processes the webcast data, thus implementing playing.

In step 404: sending the current webcast data acquired in real time to the webcast server is paused when the prohibited data exists in the current webcast data acquired in real time and a first operation request triggered by a user according to the live video data is received.

In step 405: sending the current webcast data acquired in real time to the webcast server is recovered when the prohibited data in the current webcast data acquired in real time is completely played and a second operation request triggered by the user according to the live video data is received.

The live video data corresponding to the webcast data may be played for the user to view. When prohibited video data exists in the live video data, i.e., prohibited data and index information of the prohibited video data exist in the current webcast data, the first operation request may be triggered namely, for example, a corresponding operation button is touched, so that sending the current webcast data acquired in real time to the webcast server may be paused.

If the prohibited video data in the live video data is completely played, then the second operation request may be triggered, for example, a corresponding operation button is touched, so that the current webcast data acquired in real time may be continuously sent to the webcast server.

In the embodiment, the prohibited video data in the live video data may be manually monitored by playing the acquired live video data corresponding to the webcast data for the user to view. When prohibited video data appears in the live video data, i.e., prohibited data exists in the current webcast data acquired in real time, the operation of pausing in sending the current webcast data acquired in real time to the webcast server may be triggered until the prohibited video data is completely played, and then the operation of recovering to send the current webcast data acquired in real time to the webcast server may be triggered, so that targeted monitoring may be performed on the live video data to improve the webcasting security and quality.

As another probable implementation manner, whether video data satisfying prohibited conditions exists in the live video data corresponding to the webcast data may be detected through image processing according to the acquired webcast; if yes, then the video data is identified as prohibited video data, so that sending the current webcast data acquired in real time to the webcast server may be paused until the video data satisfying the prohibited conditions does not exist in the live video data.

When the embodiment of the present disclosure is specific applied to the webcasting system as shown in FIG. 2, the sending the current webcast data acquired in real time to the webcast server, the current webcast data acquired in real time being sent to the webcast client in real time by the webcast server may specifically include:

sending the current webcast data acquired in real time to the webcast server, the current webcast data acquired in real time being transmitted to the webcast client in real time by the webcast server through a relay server and a CDN server.

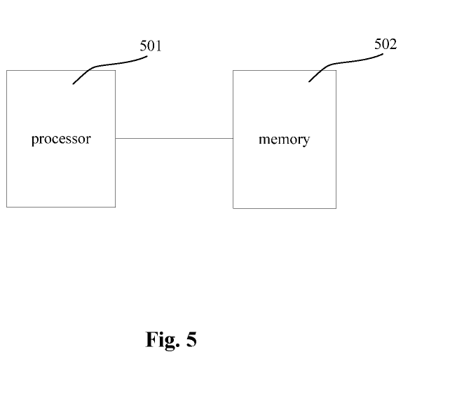

FIG. 5 is a structure diagram of one embodiment of a webcasting device provided by the embodiment of the present disclosure. The device of the embodiment may be applied to a monitoring platform in a webcasting system as shown in FIG. 1 or FIG. 2, wherein the device may include:

a processor 501; and

a memory 502 for storing instructions executable by the processor 501.

The processor 501 is configured to acquire webcast data in real time.

The processor 501 is configured to send the current webcast data acquired in real time to a webcast server, the current webcast data acquired in real time being transmitted to a webcast client in real time by the webcast server.

Wherein, the webcast data may refer to live video data, and the webcast client may immediately play the live video data after acquisition.

As another probable implementation manner, in the present webcast protocol, the webcast data transmitted is usually a video data index file, rather than the live video data, wherein the video data index file includes the index information of the live video data, for example, play address, or the like. The webcast client downloads and plays the live video data according to the acquired index information of the live video data in the video data index file.

For example, in a HLS (Http Live Streaming) protocol, the video data index file is namely an M3U8 description file, and the live video data is TS (Transport Stream, transport stream) data, wherein the M3U8 description file includes the index information of the TS data, for example, play address, or the like.

The processor 501 is configured to pause in sending the current webcast data acquired in real time to the webcast server when prohibited data exists in the current webcast data acquired in real time.

The processor 501 is configured to recover to send the current webcast data acquired in real time to the webcast server when the prohibited data in the current webcast data acquired in real time is completely played.

In the embodiment, if the prohibited data is stored in the current webcast data acquired in real time, then sending the current webcast data acquired in real time to the webcast server may be paused until the prohibited data is completely played, and then the current webcast data acquired in real time is sent to the webcast server continuously. Therefore, a user will not see prohibited contents corresponding to the prohibited data at the webcast client, which may improve the webcasting quality and increase the webcasting security.

Because pausing in sending the current webcast data acquired in real time to the webcast server will also disable the webcast client to acquire the webcast data, a live interrupt problem will appear at the webcast client. In order to further improve the webcasting quality, as another embodiment, the processor 501 is further configured to:

while pausing in sending the current webcast data acquired in real time to the webcast server, send standby data to the webcast server until the prohibited data in the current webcast data acquired in real time is completely played.

When the webcast data is the live video data, the standby data namely refers to standby video data so as to replace the prohibited data which refers to prohibited video data namely, thus the standby data is played specifically at the webcast client during the prohibited data play stage, so that the user may not see the prohibited contents, and the viewing experience of the user will not be affected, thereby assuring continuous viewing. The standby data, for example, may be advertisement data or data related to the webcast data, or the like.

When the webcast data is the video data index file of the live video data, the standby data may refer to the index information of standby video data so as to replace the prohibited data which refers to the index information of prohibited video data namely, thus the webcast client may download and play the standby video data according to the index information of the standby video data, so that the user may not see the prohibited video data, and the viewing experience of the user will not be affected, thereby assuring continuous viewing. The standby data, for example, may be advertisement data or the index information of data related to the live video data, or the like. In the possible implementation manner, as another embodiment, the processor 501 is further configured to acquire a video data index file, the video data index file including the index information of the live video data; wherein, the webcast client downloads and plays the live video data according to the index information of the live video data in the video data index file; and

update the current prohibited data in the video data index file acquired into the standby data and send the data to the webcast client.

That is, the standby data is added in the video data index file to replace the prohibited data, so that the webcast client downloads and plays the standby data directly according to the index information of the video data index file, i.e., the standby video data of the standby data index may be played during the play moment of the prohibited video data.

The processor is further configured to play live video data corresponding to the webcast data.

In the embodiment, the webcast data is a video data index file, and playing the live video data corresponding to the webcast data specifically refers to downing and playing the live video data according to the index information of the live video data in the video data index file.

Certainly, when the webcast data is live video data, the live video data can be directly played.

The processor 501 is further configured to pause in sending the current webcast data acquired in real time to the webcast server when the prohibited data exists in the current webcast data acquired in real time and a first operation request triggered by a user according to the live video data is received; and

recover to send the current webcast data acquired in real time to the webcast server when the prohibited data in the current webcast data acquired in real time is completely played and a second operation request triggered by the user according to the live video data is received.

The live video data corresponding to the webcast data may be played for the user to view. When prohibited video data exists in the live video data, the first operation request may be triggered namely, for example, a corresponding operation button is touched, so that sending the current webcast data acquired in real time to the webcast server may be paused.

If the prohibited video data in the live video data is completely played, then the second operation request may be triggered, for example, a corresponding operation button is touched, so that the current webcast data acquired in real time may be continuously sent to the webcast server.

In the embodiment, the prohibited video data in the live video data may be manually monitored by playing the acquired live video data corresponding to the webcast data for the user to view. When prohibited video data appears in the live video data, i.e., prohibited data exists in the current webcast data acquired in real time, the operation of pausing in sending the current webcast data acquired in real time to the webcast server may be triggered until the prohibited video data is completely played, and then the operation of recovering to send the current webcast data acquired in real time to the webcast server may be triggered, so that targeted monitoring may be performed on the live video data to improve the webcasting security and quality.

Certainly, the processor may detect whether video data satisfying prohibited conditions exists in the live video data corresponding to the webcast data according to the acquired webcast data or through image processing; if yes, then the video data may be identified as prohibited video data, so that sending the current webcast data acquired in real time to the webcast server may be paused until the video data satisfying the prohibited conditions does not exist in the live video data, then the processor is triggered to recover to send the current webcast data acquired in real time to the webcast server.

Wherein, when the webcasting device is specifically applied to the monitoring platform of the webcasting system as shown in FIG. 2, the processor is further configured to send the current webcast data acquired in real time to the webcast server, the current webcast data acquired in real time being transmitted to the webcast client in real time by the webcast server through a relay server and a CDN server.

The embodiment of the present disclosure also provides a webcasting system. As shown in FIG. 1, it is a structure diagram of one embodiment of a webcasting system provided by the embodiment of the present disclosure. The webcasting system may include a monitoring platform 101, a webcast server 102 connected to the monitoring platform 101, and a plurality of webcast clients 103 connected to the webcast server 102.

The monitoring platform 101 is configured with the webcasting device according to any one of the foregoing embodiments for acquiring webcast data in real time; sending the current webcast data acquired in real time to the webcast server; pausing in sending the current webcast data acquired in real time to the webcast server when prohibited data exists in the current webcast data acquired in real time; and recovering to send the current webcast data acquired in real time to the webcast server when the prohibited data in the current webcast data acquired in real time is completely played.

The webcast server 102 is configured to transmit the current webcast data acquired in real time received to the webcast client 103 in real time; and

the webcast client 103 is configured to process the webcast data and implement the play of the live video data.

Certainly, in order to improve the transmission efficiency and increase the speed of response, as another embodiment, the system, as shown in FIG. 2, may include at least one relay server 104 and at least one CDN server 105.

The webcast server 102 transmits the webcast data to the webcast client 103 in real time through the relay server and the CDN server.

Through the webcasting system provided by the embodiment of the present disclosure, the webcasting system may be improved, and the webcast security may be increased.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

The explanation above shows and describes the embodiments of the disclosure, but as previously mentioned, it should be understood that the present application is not limited to the forms disclosed herein, and shall not be deemed as an exclusion to other embodiments, but can be applied to various other combinations, amendments and circumstances, and can be modified through the foregoing teaching or technologies or knowledge of related arts within the scope of the disclosure concept herein. While modifications and changes made by those skilled in the art without departing from the spirit and scope of the present application shall all fall within the protection scope of the claims of the present application appended.

1. A webcasting method, comprising:
acquiring web cast data in real time;
sending the current webcast data acquired in real time to a webcast server, the current webcast data acquired in real time being transmitted to a webcast client in real time by the webcast server;
pausing in sending the current webcast data acquired in real time to the webcast server when prohibited data exists in the current web cast data acquired in real time; and
recovering to send the current webcast data acquired in real time to the webcast server when the prohibited data in the current webcast data acquired in real time is completely played.

2. The method according to claim 1, wherein while pausing in sending the current web cast data acquired in real time to the webcast server when the prohibited data exists in the current webcast data acquired in real time, the method further comprises:
sending standby data to the web cast server until the prohibited data in the current web cast data acquired in real time is completed.

3. The method according to claim 2, wherein the webcast data comprises a video data index file;
the acquiring the web cast data comprises:
acquiring the video data index file, the video data index file comprising the index information of live video data; wherein, the web cast client downloads and plays the live video data according to the index information of the live video data in the video data index file; and
the sending the standby data to the webcast server until the prohibited data in the current webcast data acquired in real time is completed comprises:
updating the current prohibited data in the video data index file acquired into the standby data and sending the data to the webcast client.

4. The method according to claim 1, wherein after the acquiring the webcast data, the method further comprises:
playing live video data corresponding to the webcast data;
the pausing in sending the current webcast data acquired in real time to the webcast server when the prohibited data exists in the current webcast data acquired in real time comprises:
pausing in sending the current webcast data acquired in real time to the webcast server when the prohibited data exists in the current webcast data acquired in real time and a first operation request triggered by a user according to the live video data is received; and
the recovering to send the current webcast data acquired in real time to the webcast server when the prohibited data in the current webcast data acquired in real time is completely played comprises:
recovering to send the current webcast data acquired in real time to the webcast server when the prohibited data in the current webcast data acquired in real time is completely played and a second operation request triggered by the user according to the live video data is received.

5. The method according to claim 1, wherein the sending the current webcast data acquired in real time to the webcast server, the current webcast data acquired in real time being transmitted to the webcast client in real time by the webcast server comprises:
sending the current webcast data acquired in real time to the webcast server, the current webcast data acquired in real time being transmitted to the webcast client in real time by the webcast server through a relay server and a CDN server.

6. A webcasting device, comprising:
a processor; and
a memory for storing instructions executable by the processor;
wherein the processor is configured to:
acquire web cast data in real time;
send the current webcast data acquired in real time to a webcast server, the current webcast data acquired in real time being transmitted to a webcast client in real time by the webcast server;
pause in sending the current webcast data acquired in real time to the webcast server when prohibited data exists in the current web cast data acquired in real time; and
recover to send the current webcast data acquired in real time to the webcast server when the prohibited data in the current webcast data acquired in real time is completely played.

7. The device according to claim 6, wherein the processor is further configured to:
while pause in sending the current webcast data acquired in real time to the webcast server, send standby data to the webcast server until the prohibited data in the current webcast data acquired in real time is completely played.

8. The device according to claim 7, wherein the webcast data comprises a video data index file, and the processor is further configured to:
acquire the video data index file, the video data index file comprising the index information of live video data; wherein, the webcast client downloads and plays the live video data according to the index information of the live video data in the video data index file; and
while pause in sending the current webcast data acquired in real time to the webcast server, update the current prohibited data in the video data index file acquired into the standby data and send the data to the webcast client, the standby data being configured to index preset video data.

9. The device according to claim 6, wherein the processor is further configured to:
play live video data corresponding to the webcast data;
pause in sending the current webcast data acquired in real time to the webcast server when the prohibited data exists in the current webcast data acquired in real time and a first operation request triggered by a user according to the live video data is received; and
recover to send the current webcast data acquired in real time to the webcast server when the prohibited data in the current webcast data acquired in real time is completely played and a second operation request triggered by the user according to the live video data is received.

10. The device according to claim 6, wherein the processor is further configured to: send the current webcast data acquired in real time to the webcast server, the current webcast data acquired in real time being transmitted to the webcast client in real time by the webcast server through a relay server and a CDN server.

11. A webcasting system, at least comprising a webcast server, a webcast client and a monitoring platform;
wherein, the monitoring platform is configured with the webcasting device according to claim 6.
